(19) United States
(12) Patent Application Publication
(10) Pub. No.: US 2018/0205837 A1
(43) Pub. Date: Jul. 19, 2018

(54) RELAY APPARATUS, ERROR INFORMATION MANAGEMENT SYSTEM, AND NON-TRANSITORY COMPUTER READABLE MEDIUM

(71) Applicant: FUJI XEROX CO., LTD., Tokyo (JP)

(72) Inventors: Eiji NISHI, Kanagawa (JP); Keita SAKAKURA, Kanagawa (JP); Ryuichi ISHIZUKA, Kanagawa (JP); Chigusa NAKATA, Kanagawa (JP); Hiroshi HONDA, Kanagawa (JP); Yoshihiro SEKINE, Kanagawa (JP); Kenji KUROISHI, Kanagawa (JP); Hiroshi MIKURIYA, Kanagawa (JP); Takeshi FURUYA, Kanagawa (JP)

(73) Assignee: FUJI XEROX CO., LTD., Tokyo (JP)

(21) Appl. No.: 15/786,773

(22) Filed: Oct. 18, 2017

(30) Foreign Application Priority Data
Jan. 13, 2017 (JP) 2017-003909

(51) Int. Cl. H04N 1/00; H04L 29/06; H04L 29/08

(52) U.S. Cl. CPC H04N 1/00214; H04L 2001/0097; H04L 67/02; H04L 29/06

(57) ABSTRACT

A relay apparatus includes a transmission/reception unit, a relay processing unit, an error detection unit, and an error information acquisition unit. The transmission/reception unit transmits and receives data to and from terminal apparatuses via a network. The relay processing unit causes the transmission/reception unit to transmit data, which have been transmitted from one of the terminal apparatuses and received by the transmission/reception unit, to a terminal apparatus set as a transmission destination. The error detection unit detects an error in communication processed by the relay processing unit. The error information acquisition unit acquires information about the communication in which an error has been detected by the error detection unit.

### CROSS-REFERENCE TO RELATED APPLICATIONS

This application is based on and claims priority under 35 USC 119 from Japanese Patent Application No. 2017-003909 filed Jan. 13, 2017.

### BACKGROUND

### Technical Field

The present invention relates to a relay apparatus, an error information management system, and a non-transitory computer readable medium.

### SUMMARY

According to an aspect of the present invention, there is provided a relay apparatus including: a transmission/reception unit that transmits and receives data to and from terminal apparatuses via a network; a relay processing unit that causes the transmission/reception unit to transmit data, which have been transmitted from one of the terminal apparatuses and received by the transmission/reception unit, to a terminal apparatus set as a transmission destination; an error detection unit that detects an error in communication processed by the relay processing unit; and an error information acquisition unit that acquires information about the communication in which an error has been detected by the error detection unit.

### BRIEF DESCRIPTION OF THE DRAWINGS

An exemplary embodiment of the present invention will be described in detail based on the following figures, wherein:

FIG. 1 illustrates the overall configuration of a network system to which an exemplary embodiment is applied;

FIG. 2 illustrates the functional configuration of a relay apparatus according to the exemplary embodiment;

FIG. 3 illustrates the flows of data among apparatuses of the network system illustrated in FIG. 1;

FIG. 4 is a sequence diagram illustrating how transmission and reception are performed among the apparatuses;

FIG. 5 is a flowchart illustrating operation of a terminal apparatus that serves as an information acquisition apparatus;

FIG. 6 is a flowchart illustrating operation of a terminal apparatus that serves as a server for the information processing apparatus;

FIG. 7 is a flowchart illustrating operation of the relay apparatus;

FIG. 8 is a flowchart illustrating operation of an error information management server; and

FIG. 9 illustrates the configuration of an image processing apparatus that serves as the relay apparatus.

### DETAILED DESCRIPTION

An exemplary embodiment of the present invention will be described in detail below with reference to the accompanying drawings.

### System to which Exemplary Embodiment is Applied

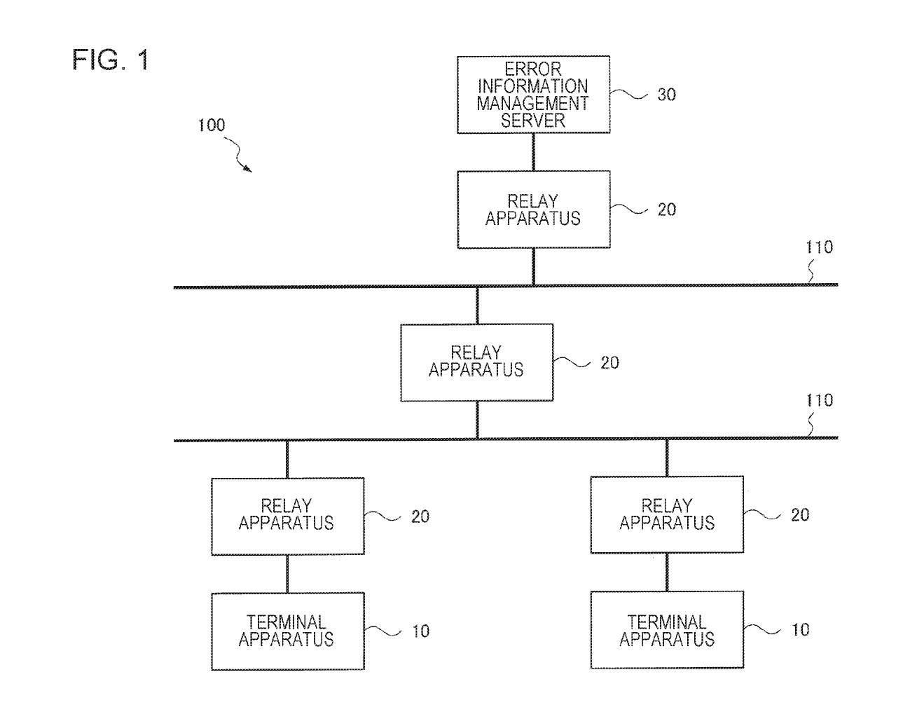

FIG. 1 illustrates the overall configuration of a network system 100 to which an exemplary embodiment is applied. As illustrated in FIG. 1, the network system 100 according to the exemplary embodiment includes terminal apparatuses 10, relay apparatuses 20, and an error information management server 30. The apparatuses are connected to each other via networks 110. In the exemplary embodiment, an error information management system is constituted by the relay apparatuses 20 and the error information management server 30.

In the example illustrated in FIG. 1, a router and plural hubs are provided as the relay apparatuses 20. The terminal apparatuses 10 and the error information management server 30 are connected to the networks 110 via the hubs which are the relay apparatuses 20. The network 110 to which the terminal apparatuses 10 are connected and the network 110 to which the error information management server 30 is connected are connected to each other via the router which is the relay apparatus 20. It is only necessary that the network system 100 to which the exemplary embodiment is applied should perform data communication among the apparatuses via the relay apparatus 20. The specific network configuration (relationship of connection among the apparatuses) is not limited to the configuration illustrated in FIG. 1. The communication scheme which is used in the exemplary embodiment is not specifically limited. Examples include packet communication.

The networks 110 are not specifically limited as long as they are communication networks for use for data communication between apparatuses. Examples include the Internet, a local area network (LAN), and a wide area network (WAN). The communication line which is used for data communication between the apparatuses may be wired or wireless. The apparatuses may be connected to each other via plural networks and communication lines.

The terminal apparatuses 10 exchange data with other apparatuses via the network 110. The terminal apparatuses 10 in the exemplary embodiment may be applied to a variety of apparatuses that are connectable to the network 110 (i.e. that include a network interface for connection to the network 110). Specifically, the terminal apparatuses 10 according to the exemplary embodiment may be personal computers, portable information terminals, etc., for example. The terminal apparatuses 10 themselves may not perform information processing. For example, the terminal apparatuses 10 according to the exemplary embodiment may be apparatuses etc. that measure information on the surrounding environment (such as temperature, humidity, and illuminance) using various sensors and that transmit obtained data to a server. Alternatively, the terminal apparatuses 10 according to the exemplary embodiment may be electronic devices etc. that include a mechanism that operates upon receiving a command from a server or another control apparatus on the network 110. Further, the terminal apparatuses 10 according to the exemplary embodiment may be servers (excluding the error information management server 30 according to the exemplary embodiment) themselves that acquire data from such various information processing apparatuses and electronic devices or that provide a service.

The relay apparatuses 20 are provided on the network 110, and relay communication between the terminal apparatuses 10 and communication between the terminal apparatus 10 and the error information management server 30. Examples include hubs, routers, gateway servers, access points (base stations) for wireless communication, etc. The relay apparatus 20 according to the exemplary embodiment may be an information processing apparatus or an electronic device that is connectable to the network 110 and that has a relay function such as a router function. For example, an image processing apparatus such as a copier installed in an office etc. may be provided with a router function and, used as the relay apparatus 20 for plural terminal apparatuses 10 in the room.

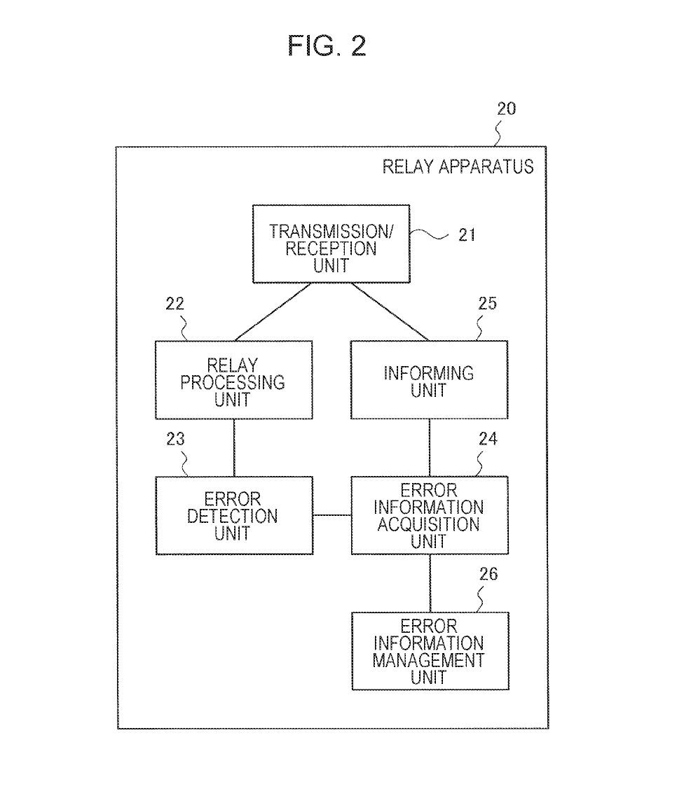

FIG. 2 illustrates the functional configuration of the relay apparatus 20 according to the exemplary embodiment. As illustrated in FIG. 2, the relay apparatus 20 according to the exemplary embodiment includes a transmission/reception unit 21, a relay processing unit 22, an error detection unit 23, an error information acquisition unit 24, and an informing unit 25. The transmission/reception unit 21 has a network interface for connection to the network 110, and transmits and receives a packet (data) to and from the terminal apparatus 10 or the error information management server 30 via the network 110. The relay processing unit 22 transmits the packet which has been received from the terminal apparatus 10 to the terminal apparatus 10 which is set as the transmission destination (address). Thus, the relay processing unit 22 has a function of analyzing the received packet and extracting a Media Access Control (MAC) address or an Internet Protocol (IP) address, for example.

The error detection unit 23 detects an error caused in communication relayed by the relay processing unit 22 in the case where such an error has occurred. For example, the error detection unit 23 may detect (determine) an error in the case where an abnormal description is found in the header or the like when the packet is analyzed, or in the case where a certain time has elapsed after transmission of the packet from the relay apparatus 20 to the terminal apparatus 10 as the transmission destination with no response sent from the terminal apparatus 10 as the transmission destination. Besides, a variety of existing error detection methods for use for normal network communication may also be used.

The error information acquisition unit 24 acquires information (hereinafter referred to as “error information”) about communication in which an error has occurred in the case where an error in communication is detected by the error detection unit 23, and informs the error information management server 30 of the error information. The error information includes at least information for specifying the terminal apparatus 10 as the transmission origin and the terminal apparatus 10 as the transmission destination for the communication in which an error has occurred, and information on the time when the communication was performed. The information for specifying the terminal apparatuses 10 as the transmission origin and the transmission destination is acquired from the header of the packet in which an error has been detected by the relay apparatus 20. The information on the communication time is acquired by providing the relay apparatus 20 with a clock function (real-time clock (RTC)) and referencing the time when the packet in which an error has been detected was received, for example.

In the exemplary embodiment, the error information acquisition unit 24 acquires not only the information for specifying the terminal apparatuses 10 as the transmission origin and the transmission destination and the communication time described above, but also information used to determine the connectivity (whether or not it is highly possible that an error occurs in communication) for a case where an apparatus of the same type is connected to the network 110 to perform communication. Specific examples of such information include information for specifying the individuality or the manufacturer of the terminal apparatus 10, information for specifying the type of a service provided through data communication, etc. The content of the error information and the method of acquiring the error information will be discussed in detail later.

The informing unit 25 informs the error information management server 30 of the error information which is acquired by the error information acquisition unit 24 about the communication in which an error has been detected by the error detection unit 23, by transmitting the error information to the error information management server 30 via the transmission/reception unit 21.

An error information management unit 26 stores the error information which is acquired by the error information acquisition unit 24 in a storage part to be discussed later. The error information management unit 26 correlates information such as the individuality, the model, the vendor (manufacturer), etc. of the individual terminal apparatuses 10 and information such as a combination of the transmission origin and the transmission destination, the type of the communication service, the type of the error, the time and date when the error occurred, etc., for example, and manages such information. Consequently, the relationship between the detailed mode of communication and the frequency of occurrence of errors may be specified using the information which is managed by the error information management unit 26. For example, the frequency of occurrence of errors may be high (the connectivity may be poor) in the case where a certain communication service is used when the terminal apparatus 10 of a certain individuality (type, or vendor) is used as the transmission origin (transmission destination) and a product of another certain model or vendor is used as the transmission destination (transmission origin). Such information is used for error detection (determination) by the error detection unit 23, for determination of the connectivity of the terminal apparatus 10 which is newly connected to the relay apparatus 20, etc., for example. In the case where occurrence of abnormal communication is concentrated on a specific time and date (day of the week or time slot) in communication between specific terminal apparatuses 10 on the basis of the error information which is managed by the error information management unit 26, the error information management unit 26 may determine, on the basis of the error information, whether or not the error has been caused in communication between the specific terminal apparatuses 10. The error information management unit 26 is not a necessary constituent element, and the error information may be managed by the error information management server 30 alone.

The error information management server 30 is connected to the network 110, and receives from the relay apparatus 20 and holds the error detection result and the error information. The error information management server 30 may be a local server built on a LAN, or may be a so-called cloud server built on the Internet. The information which is held by the error information management server 30 includes at least information for specifying the terminal apparatus 10 as the transmission origin and the terminal apparatus 10 as the transmission destination for the communication in which an error has occurred, and information on the time when the communication was performed. The information includes not only information simply indicating that an error has occurred in communication between specific individuals of the terminal apparatuses 10, but also information for use to determine the connectivity for a case where apparatuses of the same type are connected to the network 110 to perform communication. As with the error information management unit 26 of the relay apparatus 20, the error information management server 30 correlates information such as the individuality, the model, the vendor (manufacturer), etc. of the individual terminal apparatuses 10 and information such as a combination of the transmission origin and the transmission destination, the type of the communication service, the type of the error, the time and date when the error occurred, etc., for example, and manages such information. The information which is held by the error information management server 30 is used by the manufacturer etc. of a network device that serves as the terminal apparatus 10, for example, to evaluate the connectivity according to the model or the type of the communication service. Such information may be open to public so that a user may reference the information in the case where the user introduces the network device.

<Error Information>

The content of the error information which is acquired by the error information acquisition unit 24 and the method of acquiring the error information will be described. In the exemplary embodiment, as discussed above, not only an error in communication is simply detected, but also information (error information) used to determine, on the basis of error detection, the connectivity (whether or not an error occurs in communication) for a case where apparatuses of the same type are connected to the network 110 to perform communication is acquired. In the following, individual identification information, product identification information, vendor (manufacturer) identification information, service identification information, and error identification information will be described as examples of the error information which is acquired by the error information acquisition unit 24, and examples of the method of acquiring such information will be described. Communication between the terminal apparatuses 10 which are connected to the network 110 may be grasped in a hierarchical manner on the basis of an Open Systems Interconnection (OSI) reference model, for example. Different types of information are obtained in accordance with what hierarchical level (layer) of the OSI reference model the relay apparatus 20 operates in. That is, a device (relay apparatus 20) that operates in a hierarchical level of the OSI reference model may acquire, as the error information, information obtained from a packet in communication through protocols corresponding to the hierarchical level and lower hierarchical levels.

Individual Identification Information

The error information acquisition unit 24 acquires, as the error information, information for identifying the individualities of the terminal apparatus 10 as the transmission origin and the terminal apparatus 10 as the transmission destination for communication in which an error has occurred. The information for identifying the individualities of the terminal apparatuses 10 may be the MAC addresses of the transmission origin and the transmission destination for the communication in which an error has occurred, for example. The MAC address is a physical address uniquely assigned to the hardware of a network device, and a 48-bit (EUI-48) code. The MAC address is normally expressed as six sets of octets (8-bit values). Of the six octets of the MAC address, in general, the first three octets represent a vendor ID, the next one octet represents a model ID, and the last two octets represent a serial ID. Thus, the individualities of the terminal apparatuses 10 are specified using the MAC addresses. Therefore, the MAC addresses may be used as the information for identifying the individualities of the terminal apparatuses 10. If the MAC addresses of the transmission origin and the transmission destination are specified by analyzing the communication in which an error has occurred, the individualities of the terminal apparatus 10 as the transmission origin and the terminal apparatus 10 as the transmission destination for the communication are specified. The relay apparatus 20 corresponding to the second layer (layer 2: L2) or higher of the OSI reference model has a function of identifying the MAC addresses, and thus may acquire the MAC addresses as the error information.

In the case where the communication protocol which is used for communication between the terminal apparatuses 10 is the Internet Protocol (IP), IP addresses may be used as the information for identifying the individualities of the terminal apparatuses 10, for example. The IP address is used to identify a device on a network in the IP. Therefore, the IP addresses may be used as the information for identifying the individualities of the terminal apparatuses 10. If the IP addresses of the transmission origin and the transmission destination are specified by analyzing the communication in which an error has occurred, the individualities of the terminal apparatus 10 as the transmission origin and the terminal apparatus 10 as the transmission destination for the communication are specified. The relay apparatus 20 corresponding to the third layer (layer 3: L3) or higher of the OSI reference model has a function of identifying the IP addresses, and thus may acquire the IP addresses as the error information.

The individualities of the terminal apparatuses 10 as the transmission origin and the transmission destination for communication in which an error has occurred are specified as described above. However, this information only indicates the connectivity between the individual terminal apparatuses 10 (between the individualities), and thus is not very effective as information for use to determine the connectivity for a case where apparatuses of the same type are connected to the network 110 to perform communication.

Product Identification Information

The error information acquisition unit 24 acquires, as the error information, information for identifying the products (models) of the terminal apparatus 10 as the transmission origin and the terminal apparatus 10 as the transmission destination for communication in which an error has occurred. The information for identifying the products (models) of the terminal apparatuses 10 may be the MAC addresses of the transmission origin and the transmission destination for the communication in which an error has occurred, for example. Of the six octets which constitute the MAC address, as discussed above, the first three octets represent a vendor ID, the next one octet represents a model ID, and the last two octets represent a serial ID. Thus, the models of the terminal apparatuses 10 are specified using the upper four octets of the MAC addresses. Therefore, the MAC addresses may be used as the information for identifying the products (models) of the terminal apparatuses 10. If the MAC addresses of the transmission origin and the transmission destination are specified by analyzing the communication in which an error has occurred, the products (models) of the terminal apparatus 10 as the transmission origin and the terminal apparatus 10 as the transmission destination for the communication are specified. The relay apparatus 20 corresponding to the second layer or higher of the OSI reference model has a function of identifying the MAC addresses, and thus may acquire the MAC addresses as the error information. Information that indicates the correlation between the values of the MAC address and the products (models) of the terminal apparatus 10 may be held in advance in the storage part of the relay apparatus 20 in the form of a table or the like, or may be acquired from an external server via the network 110.

In the case where the communication protocol which is used for communication between the terminal apparatuses 10 is the HyperText Transfer Protocol (HTTP), the terminal apparatus 10 on the transmission side is an HTTP client, and the terminal apparatus 10 on the reception side is an HTTP server, information in the User-Agent field of the HTTP header, for example, may be used as the information for identifying the products (models) of the terminal apparatuses 10. A variety of information are recorded in the header of an HTTP message. Peculiar information on the HTTP client (such as web browser) which transmitted a request (HTTP request) message from the HTTP client to the HTTP server is recorded in the User-Agent field in the request header field added to the request message. Thus, the HTTP client which is used by the terminal apparatus 10 which transmitted the request message is specified in accordance with the information in the User-Agent field. Therefore, the information in the User-Agent field may be used as the information for identifying the products (such as the type of the web browser) of the terminal apparatuses 10.

In order to use the information in the User-Agent field as the information for identifying the products (such as the type of the web browser) of the terminal apparatuses 10, it is necessary that the error information acquisition unit 24 should have a function of analyzing the HTTP header. Therefore, the information in the User-Agent field may not be used as the error information with only the intrinsic function of a hub that operates in the second layer of the OSI reference model or a router that operates in the third layer. Thus, in the case where the information in the User-Agent field is used as the error information, it is necessary that the relay apparatus 20 should have a processing part that analyzes the HTTP header. Specifically, the processing part is implemented by a memory that stores a program for analyzing the HTTP header and a processor that executes the program which is stored in the memory to analyze the HTTP header, for example. Information that indicates the correlation between the information in the User-Agent field and the products (such as the type of the web browser) of the terminal apparatus 10 may be held in advance in the storage part of the relay apparatus 20 in the form of a table or the like, or may be acquired from an external server via the network 110.

The products (models) of the terminal apparatuses 10 as the transmission origin and the transmission destination for communication in which an error has occurred are specified as described above. This information is effective as information for use to determine the connectivity for a case where communication is performed with a combination of products (models) of the same type as the terminal apparatus 10 for which an error has occurred in the actual communication.

Vendor (Manufacturer) Identification Information

The error information acquisition unit 24 acquires, as the error information, information for identifying the vendors (manufacturers) of the terminal apparatus 10 as the transmission origin and the terminal apparatus 10 as the transmission destination for communication in which an error has occurred. The information for identifying the vendors (manufacturers) of the terminal apparatuses 10 may be the MAC addresses of the transmission origin and the transmission destination for the communication in which an error has occurred, for example. Of the six octets which constitute the MAC address, as discussed above, the first three octets represent a vendor ID, the next one octet represents a model ID, and the last two octets represent a serial ID. Thus, the vendors (manufacturers) which supply the terminal apparatuses 10 are specified by the upper three octets of the MAC addresses. Therefore, the MAC addresses may be used as the information for identifying the vendors (manufacturers) of the terminal apparatuses 10. If the MAC addresses of the transmission origin and the transmission destination are specified by analyzing the communication in which an error has occurred, the vendors (manufacturers) of the terminal apparatus 10 as the transmission origin and the terminal apparatus 10 as the transmission destination for the communication are specified. The relay apparatus 20 corresponding to the second layer or higher of the OSI reference model has a function of identifying the MAC addresses, and thus may acquire the MAC addresses as the error information. Information that indicates the correlation between the values of the MAC address and the vendors (manufacturers) of the terminal apparatus 10 may be held in advance in the storage part of the relay apparatus 20 in the form of a table or the like, or may be acquired from an external server via the network 110.

The vendors (manufacturers) of the terminal apparatuses 10 as the transmission origin and the transmission destination for communication in which an error has occurred are specified as described above. This information is effective as information for use to determine the connectivity for a case where communication is performed with a combination of products (models) provided from the same vendor (manufacturer) as the terminal apparatus 10 for which an error has occurred in the actual communication.

Service Identification Information

The error information acquisition unit 24 acquires, as the error information, information for identifying the communication service for communication in which an error has occurred. In the case where the communication protocol which is used for communication between the terminal apparatuses 10 is the Transmission Control Protocol (TCP), port numbers may be used as the information for identifying the communication service, for example. In TCP communication, the port numbers which serve as auxiliary addresses described in the TCP header are used, in addition to the IP addresses, to identify an upper protocol (e.g. a protocol used by an application that transmitted and received data) that handles data transmitted in IP communication. Some of the port numbers are assigned to specific applications. Therefore, services provided by the corresponding applications are specified using the port numbers. For example, port numbers of 20 and 21 are assigned to the File Transfer Protocol (FTP), and a port number of 22 is assigned to the Secure Shell (SSH). A port number of 25 is assigned to the Simple Mail Transfer Protocol (SMTP), and a port number of 80 is assigned to the HTTP. Thus, if a port number is specified by analyzing the communication in which an error has occurred, the upper protocol which uses the port number is specified depending on the specified port number, and it is specified that an error has occurred in the communication service which is provided using the upper protocol.

In order to use the port numbers as the information for identifying the communication service, it is necessary that the error information acquisition unit 24 should have a function of analyzing the TCP header. The port numbers are handled in the fourth layer of the OSI reference model. Thus, information on the type of an information service which is based on the port number may not be used as the error information with only the intrinsic function of a hub that operates in the second layer or a router that operates in the third layer. Thus, in the case where the information on the type of an information service which is based on the port number is used as the error information, it is necessary that the relay apparatus 20 should have a processing part that analyzes the TCP header. Specifically, the processing part is implemented by a memory that stores a program for analyzing the TCP header and a processor that executes the program which is stored in the memory to analyze the TCP header, for example. Information that indicates the correlation between the port numbers and the communication service may be held in advance in the storage part of the relay apparatus 20 in the form of a table or the like, or may be acquired from an external server via the network 110.

In the case where the communication protocol which is used for communication between the terminal apparatuses 10 is the HyperText Transfer Protocol (HTTP), the terminal apparatus 10 on the transmission side is an HTTP client, and the terminal apparatus 10 on the reception side is an HTTP server, information in the Uniform Resource Locator (URL) of an HTTP request may be used as the information for identifying the communication service. A path name of a resource such as a file is occasionally added to the URL of the HTTP request in addition to a portion for a Fully Qualified Domain Name (FQDN). In the case where the server to be accessed is not a file server but a server that provides some communication service, information (such as a protocol name) for calling up the function of the server (communication service) is described in the path name. Thus, if a communication service provided by the server is specified by analyzing the URL of an HTTP request for communication in which an error has occurred, it is specified that an error has occurred in the communication service.

In the case where information on the URL of an HTTP request is used as the error information, the intrinsic function of a hub that operates in the second layer or a router that operates in the third layer is not sufficient, and it is not necessary that the relay apparatus 20 should have a processing part that analyzes the HTTP request. Specifically, the processing part is implemented by a memory that stores a program for analyzing the HTTP request and a processor that executes the program which is stored in the memory to analyze the HTTP request, for example. Information that indicates the correlation between the path name and the communication service may be held in advance in the storage part of the relay apparatus 20 in the form of a table or the like, or may be acquired from an external server via the network 110.

In the case where Extensible Markup Language (XML) data are transmitted and received in communication between the terminal apparatuses 10, and if an attribute “xmlns:” that indicates a name space is described, information designated using the attribute “xmlns:” may occasionally be used as the information for identifying the communication service. In the XML, original markup languages (tag sets) may be designed freely. The tag sets are identified using a Uniform Resource Identifier (URI). The URI of a tag set used in the XML data is designated using the attribute “xmlns:”. Thus, in the case where a specific communication service is provided by the tag set, the communication service which is provided by the tag set may be specified in accordance with information with the attribute “xmlns:”. If a communication service is specified in accordance with the information which is designated with the attribute “xmlns:” by analyzing the XML data for communication in which an error has occurred, it is specified that an error has occurred in the communication service.

In order to use the information which is designated with the attribute “xmlns:” of the XML data as the error information, it is necessary that the error information acquisition unit 24 should have a function of analyzing the XML data. Therefore, the information which is designated with the attribute “xmlns:” of the XML data may not be used as the error information with only the intrinsic function of a hub that operates in the second layer of the OSI reference model or a router that operates in the third layer. Thus, in the case where the information which is designated with the attribute “xmlns:” of the XML data is used as the error information, it is necessary that the relay apparatus 20 should have a processing part that analyzes the XML data. Specifically, the processing part is implemented by a memory that stores a program for analyzing the XML data and a processor that executes the program which is stored in the memory to analyze the XML data, for example. Information that indicates the correlation between the information which is designated with the attribute “xmlns:” of the XML data and the communication service may be held in advance in the storage part of the relay apparatus 20 in the form of a table or the like, or may be acquired from an external server via the network 110.

The communication service for communication in which an error has occurred is specified as described above. This information is effective as information for use to determine the connectivity for a case where a specific communication service is to be used. The information is particularly effective as information for use to determine the connectivity for a case where a specific communication service is to be used with a combination of specific products when the information is combined with information on the products (models) or the vendors (manufacturers) of the terminal apparatuses 10 as the transmission origin and the transmission destination for the communication in which an error has occurred discussed above.

Error Identification Information

The error information acquisition unit 24 acquires, as the error information, information for identifying the type of the error which has occurred. In the case where the communication protocol which is used for communication between the terminal apparatuses 10 is the HTTP, the terminal apparatus 10 on the transmission side is an HTTP server, and the terminal apparatus 10 on the reception side is an HTTP client, information on a state code (HTTP status code) to be added to a response (HTTP response) message may be used as the information for identifying the type of the error, for example. The HTTP status code is a code that represents the meaning of a response, and is constituted of a three-digit number. Occurrence of an error and the type of the error which has occurred may be specified using the HTTP status code. An HTTP status code in the 400's indicates an error on the client side (an error in a request from the client). An HTTP status code in the 500's indicates an error on the server side (an error in processing of a request by the server).

In the case where the HTTP status code is used as the error information, the intrinsic function of a hub that operates in the second layer or a router that operates in the third layer is not sufficient, and it is not necessary that the relay apparatus 20 should have a processing part that analyzes the HTTP response. Specifically, the processing part is implemented by a memory that stores a program for analyzing the HTTP response and a processor that executes the program which is stored in the memory to analyze the HTTP response, for example.

The error information acquisition unit 24 acquires, as the error information, information that indicates the occurrence of an error. In the case where the communication protocol which is used for communication between the terminal apparatuses 10 is the TCP, a reset (RST) packet may be used as the information which indicates the occurrence of an error, for example. The terminal apparatus 10 which has received a wrong packet in TCP communication transmits to the terminal apparatus 10 which transmitted the wrong packet an RST packet in order to command resetting of the communication. Thus, if an RST packet is detected in the relay apparatus 20, it is specified that an error has occurred in the communication in which the RST packet is transmitted and received.

In the case where the RST packet is used as the error information, the intrinsic function of a hub that operates in the second layer or a router that operates in the third layer is not sufficient, and it is not necessary that the relay apparatus 20 should have a processing part that analyzes a packet transmitted and received in TCP communication. Specifically, the processing part is implemented by a memory that stores a program for analyzing the packet in TCP communication and a processor that executes the program which is stored in the memory to analyze the packet in TCP communication, for example.

Occurrence of an error and the type of the error which has occurred is specified as described above. This information may indicate what error possibly occurs in the case where a specific communication service is to be used with a combination of specific products when the information is combined with information on the products (models), the vendors (manufacturers), the communication service, etc. of the terminal apparatuses 10 as the transmission origin and the transmission destination for the communication in which an error has occurred discussed above, and is particularly effective as information for use to determine the detailed connectivity between the products.

Some examples of information that may be used as the error information and examples of the method of acquiring such information have been described above. For some types of the error information, plural acquisition methods corresponding to different hierarchical levels of the OSI reference model, such as methods of acquiring product identification information, for example, have been described. Error information acquired from a lower hierarchical level of the OSI reference model is highly versatile and not affected by a difference in an upper protocol, compared to error information acquired from a higher hierarchical level. With only the error information which is acquired from a lower hierarchical level, however, occurrence of an error is possibly missed in the case where data transmission in a lower protocol is normal but data transmission through connection in an upper protocol has failed. Thus, in the actual operation, error information to be acquired may be acquired by plural acquisition methods including different hierarchical levels of the OSI reference model in accordance with the specific execution environment, the specifications, etc. to which the network system 100 is applied.

<Operation of Apparatuses>

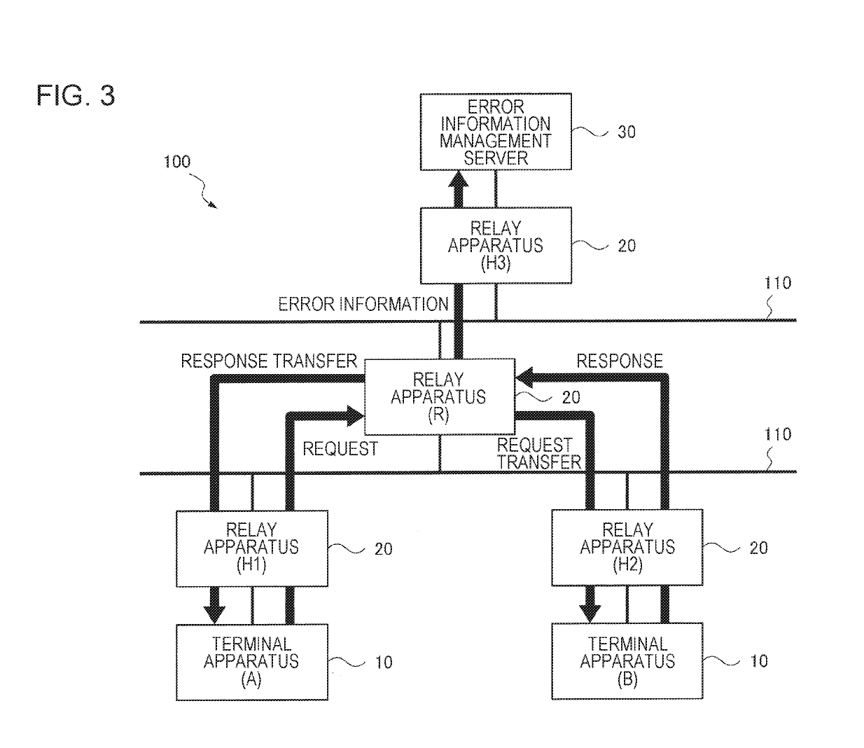

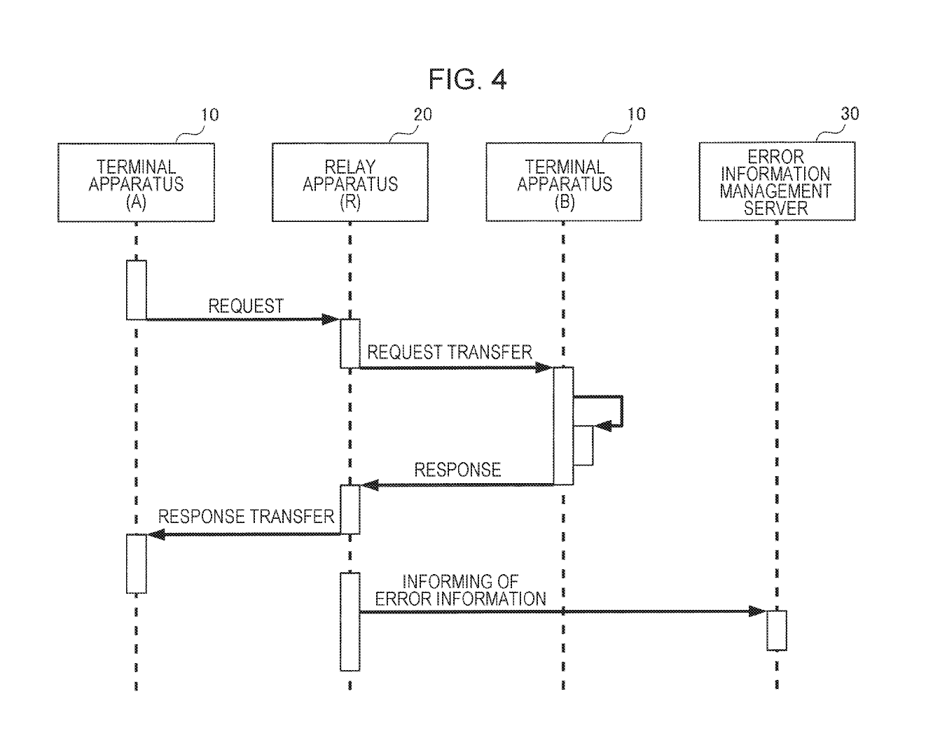

FIG. 3 illustrates the flows of data among the apparatuses of the network system 100 illustrated in FIG. 1. FIG. 4 is a sequence diagram illustrating how transmission and reception are performed among the apparatuses. In the example illustrated in FIG. 3, an apparatus A that serves as the terminal apparatus 10 and an apparatus B that serves as the terminal apparatus 10 constitute a client server system, and the flows of data transmission and reception are indicated for operation in which a request is transmitted from the apparatus A to the apparatus B and a response is returned from the apparatus B to the apparatus A. In the example illustrated in FIG. 3, hubs H1, H2, and H3 that connect the terminal apparatuses 10, the error information management server 30, and the networks 110 and a router R that connects the network 110 to which the terminal apparatuses 10 are connected and the network 110 to which the error information management server 30 is connected are provided as the relay apparatuses 20. Communication between the apparatuses is all performed via the router R which serves as the relay apparatus 20. In this operation example, the relay apparatus 20 which acquires the error information according to the exemplary embodiment serves as the router R. That is, the hubs H1, H2, and H3 illustrated in FIG. 3 do not function as the relay apparatus 20 according to the exemplary embodiment. Thus, the hubs H1, H2, and H3 are not described in FIG. 4. Only the router R functions as the relay apparatus 20 according to the exemplary embodiment. However, the hubs H1, H2, and H3 may function as the relay apparatus 20 according to the exemplary embodiment.

In the example illustrated in FIGS. 3 and 4, first, request data (request packet) are transmitted from the apparatus A. The request data which are transmitted from the apparatus A are sent to the apparatus B by way of the hub H1, the router R which serves as the relay apparatus 20, and the hub H2. Response data (response packet) to the request are transmitted from the apparatus B. The response data which are transmitted from the apparatus B are sent to the apparatus A by way of the hub H2, the router R, and the hub H1.

It is assumed that an error has occurred in the communication of the response data from the apparatus B to the apparatus A. In this case, the router R which serves as the relay apparatus 20 according to the exemplary embodiment transfers the response data to the apparatus A, acquires error information, which is information about the error which has occurred in the communication between the apparatus A and the apparatus B (i.e. information indicating that there is a problem with the connectivity between the apparatus A and the apparatus B), and transmits the error information to the error information management server 30. The error information which is transmitted from the router R is received by the error information management server 30 by way of the hub H3, and held. The error information which is sent from the router R to the error information management server 30 includes, in addition to information indicating that an error has occurred, information (information on the individuality, information for specifying the product or the manufacturer) about the terminal apparatuses 10 (the apparatus A and the apparatus B) as the transmission destination and the transmission origin for the communication in which an error has occurred, information (information indicating the type of the communication service, information indicating the type of the error) about the communication in which an error has occurred, etc. as discussed above. A case where an error has occurred in the communication of the response data from the apparatus B to the apparatus A has been described. Also in the case where an error has occurred in communication of the request data from the apparatus A to the apparatus B, the router R transfers the request data to the apparatus B, acquires error information on the communication between the apparatus A and the apparatus B, and transmits the error information to the error information management server 30.

The network system 100 illustrated in FIGS. 1 and 3 may be applied to a client server system that includes an information acquisition apparatus that serves as a client that has a data acquisition part such as a sensor and that acquires and outputs data, and a server that manages the data which are output from the information acquisition apparatus. An example of operation of the apparatuses, in which the apparatus A illustrated in FIG. 3 serves as the information acquisition apparatus and the apparatus B serves as the server for the information acquisition apparatus, will be described by way of example.

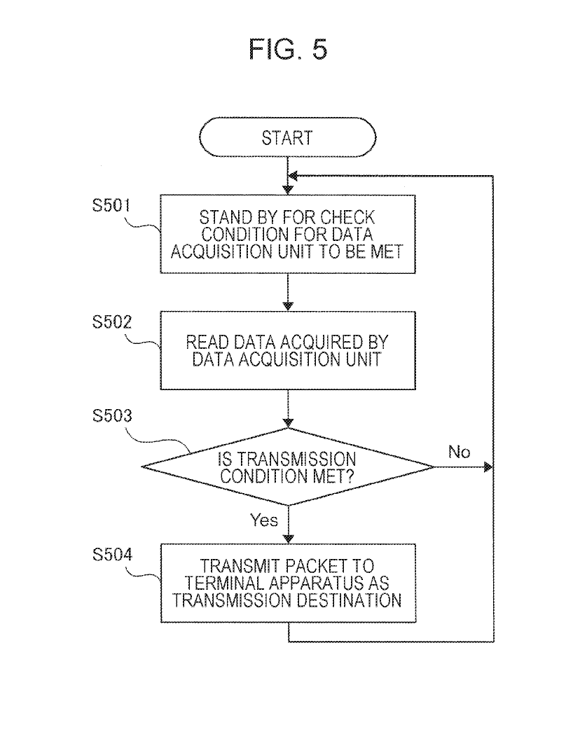

FIG. 5 is a flowchart illustrating operation of the terminal apparatus 10 (apparatus A) as the information acquisition apparatus. As illustrated in FIG. 5, the terminal apparatus 10 (apparatus A; information acquisition apparatus) first stands by for a check condition for the data acquisition part (such as a sensor) to be met (S501). The check condition is set in accordance with the content of data acquired by the terminal apparatus 10 (apparatus A; information acquisition apparatus), the specifications of the terminal apparatus 10 (apparatus A; information acquisition apparatus) itself, etc. A temporal condition may be set as the check condition in order to regularly acquire data to be acquired or acquire data at a fixed time, for example. A fact that data acquired by the data acquisition part has come to have a present content, such as a case where the ambient temperature has reached a set value, may be used as the check condition.

When the check condition is met, the terminal apparatus 10 (apparatus A; information acquisition apparatus) next reads data (such as a value from a sensor) acquired by the data acquisition part (S502). The terminal apparatus 10 (apparatus A; information acquisition apparatus) determines whether or not a condition for transmission to the terminal apparatus 10 (apparatus B) as the server for the information processing apparatus is met. If the transmission condition is met (Yes in S503), the terminal apparatus 10 (apparatus A; information acquisition apparatus) transmits a packet of the data which are read in S502 to the terminal apparatus 10 (apparatus B; server) (S504). The transmission condition is set in accordance with the content of data acquired by the terminal apparatus 10 (apparatus A; information acquisition apparatus), the specifications of the terminal apparatus 10 (apparatus A; information acquisition apparatus) and the terminal apparatus 10 (apparatus B; server), etc. For example, establishment of connection between the terminal apparatus 10 (apparatus A; information acquisition apparatus) and the terminal apparatus 10 (apparatus B; server), the terminal apparatus 10 (apparatus B; server) permitting transmission, etc. may be set as the transmission condition.

In the case where the condition for transmission to the terminal apparatus 10 (apparatus B; server) is not met (No in S503), and after the data are transmitted to the terminal apparatus 10 (apparatus B; server) in S504, the terminal apparatus 10 (apparatus A; information acquisition apparatus) returns to S501, and stands by for the check condition for the data acquisition part to be met. In the case where the transmission condition is not met (No in S503), the terminal apparatus 10 (apparatus A; information acquisition apparatus) may stand by for the transmission condition to be met, rather than returning to S501, depending on the content of data acquired by the terminal apparatus 10 (apparatus A; information acquisition apparatus), the specifications of the terminal apparatus 10 (apparatus A; information acquisition apparatus) and the terminal apparatus 10 (apparatus B; server), etc. In this case, the terminal apparatus 10 (apparatus A; information acquisition apparatus) holds the data which are acquired in S502, and transmits a packet of the held data to the terminal apparatus 10 (apparatus B; server) if the transmission condition is met.

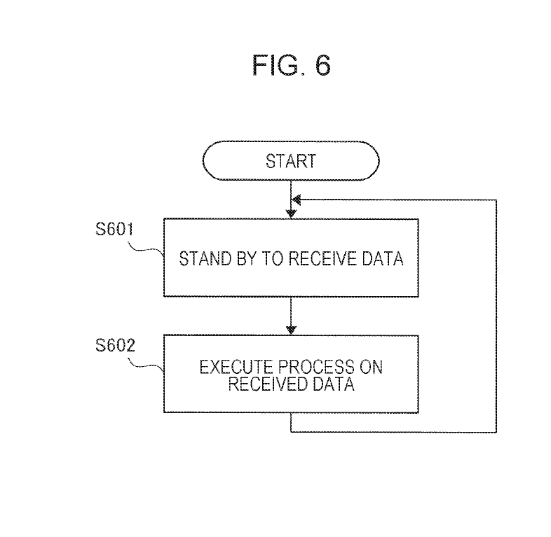

FIG. 6 is a flowchart illustrating operation of the terminal apparatus 10 (apparatus B) which serves as the server for the information processing apparatus. As illustrated in FIG. 6, in a normal state, the terminal apparatus 10 (apparatus B; server) stands by to receive data from another terminal apparatus 10 at all times (S601). Some communication condition may be provided for the terminal apparatus 10 (apparatus B; server) to stand by for reception. In this case, the communication condition is set in accordance with the content of data acquired by the terminal apparatus 10 (apparatus A; information acquisition apparatus), the specifications of the terminal apparatus 10 (apparatus A; information acquisition apparatus) and the terminal apparatus 10 (apparatus B; server), etc. For example, setting may be made so as to receive data only at a preset time, or receive data from a specific terminal apparatus 10 only after data are received from another specific terminal apparatus 10.

When data are sent from the terminal apparatus 10 (apparatus A; information acquisition apparatus) when the terminal apparatus 10 (apparatus B; server) is standing by for reception, the terminal apparatus 10 (apparatus B; server) receives the data, and executes a process on the received data (S602) in accordance with the function of the terminal apparatus 10 (apparatus B; server), such as storing the data in a storage apparatus such as a magnetic disk apparatus and managing the data. Then, the terminal apparatus 10 (apparatus B; server) stands by for reception again.

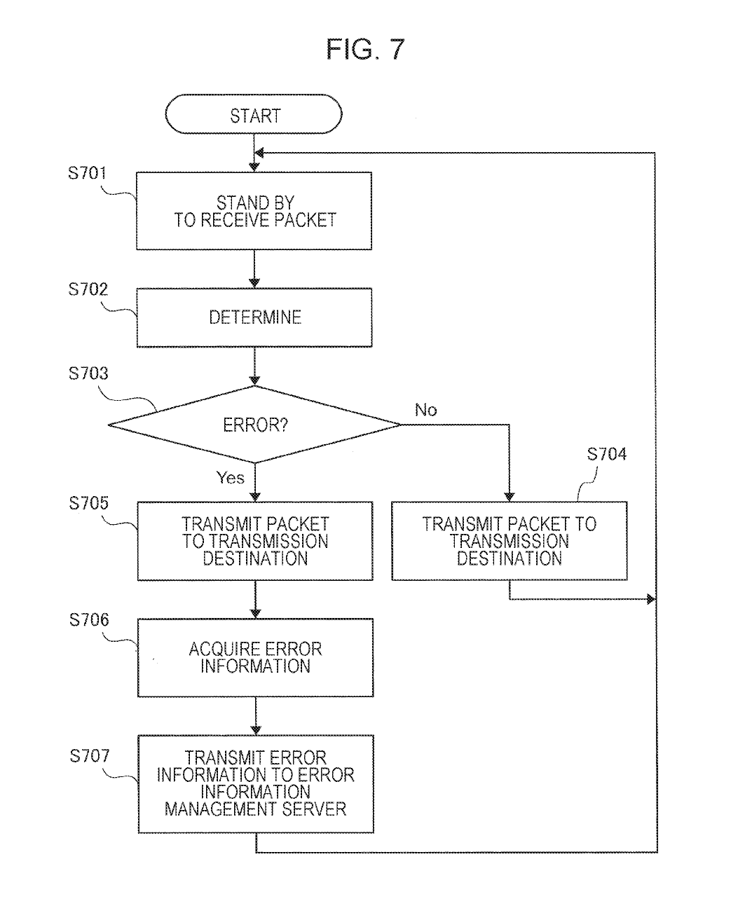

FIG. 7 is a flowchart illustrating operation of the relay apparatus 20 (router R). As illustrated in FIG. 7, in a normal state, the relay apparatus 20 (router R) stands by to receive a packet to be relayed at all times (S701). When a packet to be relayed is received, the relay apparatus 20 (router R) determines whether or not communication of the received packet is normal (makes an error determination) (S702). In the case where an error is not determined (No in S703), the relay apparatus 20 (router R) transmits the packet to the terminal apparatus 10 as the transmission destination (S704), and returns to stand by to receive a packet to be relayed.

In the case where an error is determined (Yes in S703), on the other hand, the relay apparatus 20 (router R) transmits the packet to the terminal apparatus 10 as the transmission destination (S705), analyzes the packet, and acquires error information on the communication in which an error has been determined (S706). The relay apparatus 20 (router R) transmits the acquired error information to the error information management server 30 (S707), and returns to stand by to receive a packet to be relayed.

In the example of operation of the relay apparatus 20 (router R) illustrated in FIG. 7, the received packet is transmitted to the terminal apparatus 10 as the transmission destination (S704 and 5705) after an error determination is made (S702 and S703). On the contrary, an error determination may be made after the received packet is transmitted to the terminal apparatus 10 as the transmission destination.

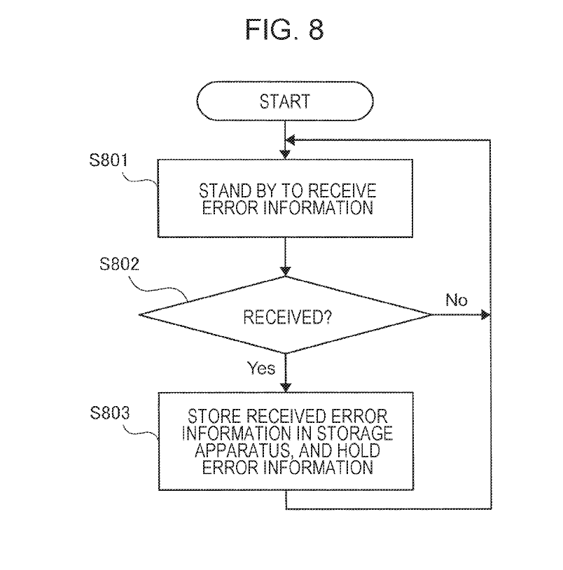

FIG. 8 is a flowchart illustrating operation of the error information management server 30. As illustrated in FIG. 8, in a normal state, the error information management server 30 stands by to receive error information from the relay apparatus 20 at all times (S801 and S802). When the error information is received from the relay apparatus 20 (Yes in S802), the error information management server 30 stores the received error information in a storage apparatus such as a magnetic disk apparatus, and holds the error information (S803).

<Configuration of Image Processing Apparatus as Example of Relay Apparatus 20>

A variety of devices are used as the relay apparatus 20 according to the exemplary embodiment in accordance with the configuration of the networks 110. In the case where information obtained from a packet (in particular, the header) for TCP communication or HTTP communication is used as the error information as discussed above, a gateway server that has a function of processing a packet for such protocols, rather than a simple hub or router, is used as the relay apparatus 20. A hub or a router may be provided with a processing part that processes a packet for such protocols to be used as the relay apparatus 20 according to the exemplary embodiment. A configuration example for a case where an image processing apparatus that serves as a multi-function device that has a copying function, an image reading function, a printing function, etc. and that includes a network interface is used as the relay apparatus 20 will be described by way of example.

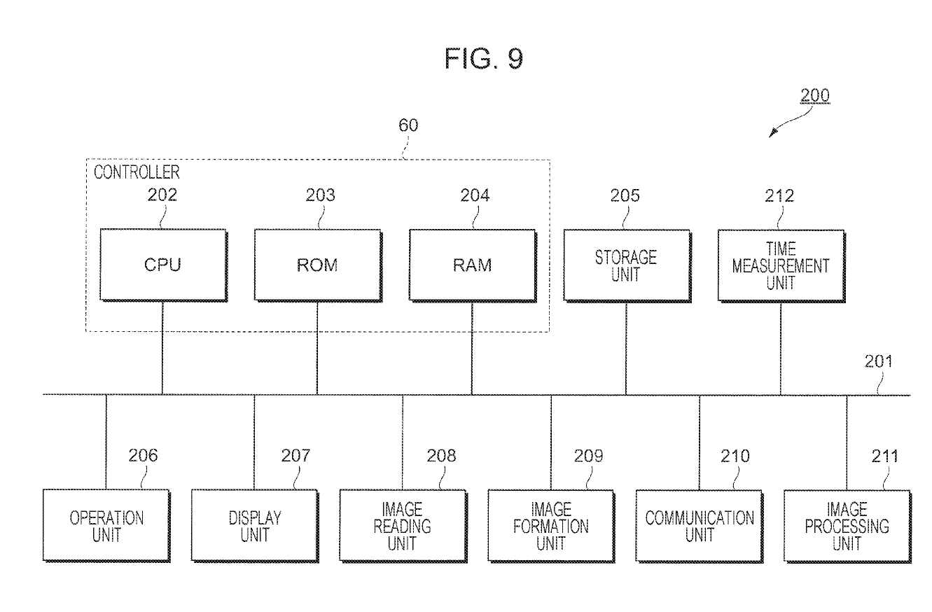

FIG. 9 illustrates the configuration of an image processing apparatus 200.

In the configuration illustrated in FIG. 9, the image processing apparatus 200 includes a central processing unit (CPU) 202, a read only memory (ROM) 203, and a random access memory (RAM) 204 that constitutes a controller 60. The image processing apparatus 200 also includes a storage unit 205, an operation unit 206, a display unit 207, an image reading unit 208, an image formation unit 209, a communication unit 210, an image processing unit 211, and a time measurement unit 212. These various functional units are connected to a bus 201, and exchange data with each other via the bus 201.

The operation unit 206 receives an operation by a user. The operation unit 206 is constituted of hardware keys, for example. Alternatively, the operation unit 206 is constituted of a touch sensor that outputs a control signal that matches a pressed position, for example. The operation unit 206 may be constituted as a touch screen that is a combination of the touch sensor and a liquid crystal display that constitutes the display unit 207 to be discussed later.

The display unit 207 is an example of a display part, and is constituted of a liquid crystal display, for example. Under control by the CPU 202, the display unit 207 displays information about the image processing apparatus 200. The display unit 207 displays a menu screen to be referenced by the user when the user operates the image processing apparatus 200. That is, the operation unit 206 described above and the display unit 207 are combined with each other to function as a user interface unit of the image processing apparatus 200.

The image reading unit 208 is constituted of a so-called scanner apparatus, and optically reads an image on a document set on the image reading unit 208 and generates a read image (image data). Examples of the image reading scheme include a CCD type in which light radiated from a light source and reflected by the document is contracted using a lens to be received by charge coupled devices (CCD) and a CIS type in which light sequentially radiated from a light emitting diode (LED) light source and reflected by the document is received by a contact image sensor (CIS).

The image formation unit 209 is an example of an image forming part, and forms an image based on image data using an image forming material on paper that is an example of a recording material. Examples of the scheme for forming an image on the recording material include an electrophotographic system in which toner adhering to a photosensitive body is transferred onto the recording material to form an image and an inkjet type in which ink is injected onto the recording material to form an image.

The communication unit 210 has a network interface that communicates with the terminal apparatuses 10 and the error information management server 30 via the networks 110, and functions as the transmission/reception unit 21 of the relay apparatus 20. Although not described distinctively, in the case where the image processing apparatus 200 has a facsimile function, the communication unit 210 also has a function for connection to a telephone line for facsimile transmission and reception.

The image processing unit 211 includes a processor that serves as a computation part and a work memory, and performs image processing such as color correction and tone correction on an image represented by the image data. The CPU 202 of the controller 60 may also be used as the processor, and the RAM 204 of the controller 60 may also be used as the work memory.

The time measurement unit 212 is an example of a time measurement part that measures the time. The time measurement unit 212 is implemented by a real-time clock (RTC), for example. The time measurement unit 212 has battery backup provided by a peculiar power source, for example, and operates to continuously measure the time even when a power source for the image processing apparatus 200 is disconnected.

The storage unit 205 is an example of the storage part, and is constituted of a storage apparatus such as a hard disk apparatus, for example. The storage unit 205 stores image data such as the read image which is generated by the image reading unit 208.

Among the CPU 202, the ROM 203, and the RAM 204 which constitute the controller 60, the ROM 203 stores a program to be executed by the CPU 202. The CPU 202 reads the program which is stored in the ROM 203, and executes the program using the RAM 204 as the work area. A program stored in the storage unit 205 may be read into the RAM 204, and the program which is read into the RAM 204 may be executed by the CPU 202.

The CPU 202 executes a program to control the various units of the image processing apparatus 200. In the exemplary embodiment, in particular, when the program is executed by the CPU 202, the functions of the error detection unit 23 and the error information acquisition unit 24 of the relay apparatus 20 illustrated in FIG. 2 are implemented by the controller 60. The functions of the relay processing unit 22 and the informing unit 25 illustrated in FIG. 2 are implemented by the controller 60 and the communication unit 210. In the exemplary embodiment, in the case where error information is acquired by analyzing packet information such as a header based on various protocols such as TCP and HTTP, XML data, etc. as the function of the error information acquisition unit 24, a program that analyzes such information may be stored in the ROM 203 or the like, and an analysis function may be implemented when the CPU 202 executes the program.

<Modifications>

The relay apparatus 20 determines mainly on the basis of information obtained by analyzing a received packet whether or not an error is caused in communication. However, the relay apparatus 20 may determines an error in the case where a certain time has elapsed with no response message to a request message sent from the terminal apparatus 10. Further, control may be performed so as not to determine an error exceptionally in a specific case even in the case where no response message is returned. For example, information on the time and date when the relay apparatus 20 transmitted a request message is held in the relay apparatus 20 or the error information management server 30. The information on the time and date is acquired using a clock function of the time measurement unit 212 etc. illustrated in FIG. 9, for example. In the case where events in which no response message is returned are concentrated on a specific time slot of the day, a specific day of the week, etc., it is considered that there is no problem with the connectivity between the terminal apparatuses 10, and that the terminal apparatus 10 as the destination for transmission of the request message is not turned on etc. in the time slot. For example, in the case where a response message is not returned from the server (terminal apparatus 10) as the destination for transmission of the request message from 18:00 every day to 9:00 the next day, it is considered that service reception is suspended since it is after office hours, rather than a problem with the connectivity between the terminal apparatuses 10. In the case where a response message is not returned from the server (terminal apparatus 10) as the destination for transmission of the request message from 0:00 to 3:00 every Sunday, meanwhile, it is considered that service reception is suspended since server maintenance is being performed, rather than a problem with the connectivity between the terminal apparatuses 10. Thus, an error may not be determined in such cases. In the case where the time and date (such as the day of the week and the time slot) when a specific event occurs in communication is non-uniform, besides the event in which a response message is not returned as described above, it may be determined in accordance with the non-uniformity (using the degree of non-uniformity as a determination condition) that an error is caused in communication in which the specific event has occurred.

In the operation example described with reference to FIGS. 3 to 8, the relay apparatus 20 transmits the determination result and error information to the error information management server 30 in the case where an error is determined. In contrast, information indicating that communication was performed (communication was relayed) may be transmitted to the error information management server 30 to be held and managed by the error information management server 30 also in the case where an error is not determined. In this way, not only information on a combination of the terminal apparatuses 10 with a connectivity problem but also information on a combination of the terminal apparatuses 10 with no connectivity problem (for which no error occurs) may be obtained.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A relay apparatus comprising:
a transmission/reception unit that transmits and receives data to and from terminal apparatuses via a network;
a relay processing unit that causes the transmission/reception unit to transmit data, which have been transmitted from one of the terminal apparatuses and received by the transmission/reception unit, to a terminal apparatus set as a transmission destination;
an error detection unit that detects an error in communication processed by the relay processing unit; and
an error information acquisition unit that acquires information about the communication in which an error has been detected by the error detection unit.

2. The relay apparatus according to claim 1,
wherein the error information acquisition unit acquires information for specifying a mode of the communication in which an error has been detected, on the basis of information on a packet in the communication in which an error has been detected.

3. The relay apparatus according to claim 2,
wherein the error information acquisition unit acquires information for specifying the terminal apparatus which performed the communication in which an error has been detected, on the basis of Media Access Control (MAC) addresses of a transmission origin and the transmission destination for the communication in which an error has been detected.

4. The relay apparatus according to claim 2,
wherein the error information acquisition unit acquires information for specifying a supplier of the terminal apparatus which performed the communication in which an error has been detected, on the basis of Media Access Control (MAC) addresses of a transmission origin and the transmission destination for the communication in which an error has been detected.

5. The relay apparatus according to claim 1, further comprising:
a time measurement unit that measures a time when communication is performed,
wherein, in a case where a time and date when a specific event about communication occurs is non-uniform, the error detection unit determines communication in which the specific event has occurred as an error using a degree of non-uniformity as a determination condition.

6. The relay apparatus according to claim 5,
wherein, even in a case of occurrence of an event in which a response message to a request message received at a specific terminal apparatus is not returned for a certain time, the error detection unit does not determine an error in a case where occurrence of such an event is concentrated on a specific time.

7. An error information management system comprising:
a relay apparatus that relays communication between terminal apparatuses performed via a network; and
a server connected to the relay apparatus,
wherein the relay apparatus includes
a relay processing unit that receives data transmitted from one of the terminal apparatuses and that transmits the data to a terminal apparatus set as a transmission destination,
an error detection unit that detects an error in communication processed by the relay processing unit,
an error information acquisition unit that acquires information about the communication in which an error has been detected by the error detection unit, and
wherein the server stores and manages the information which has been acquired by error information acquisition units of a plurality of relay apparatuses.

8. A non-transitory computer readable medium storing a program causing a computer of a relay apparatus to execute a process for relaying communication between terminal apparatuses performed via a network, the process comprising:
receiving data transmitted from one of the terminal apparatuses and transmitting the data to a terminal apparatus set as a transmission destination;
detecting an error in communication processed in the receiving and the transmitting; and
acquiring information about the communication in which an error has been detected in the detecting.
